(19) United States
(12) Patent Application Publication
(10) Pub. No.: US 2014/0222837 A1
(43) Pub. Date: Aug. 7, 2014

(54) AUTOMATED QUALITY TOOL FOR MONITORING OF SAMPLES IN A HIGH-THROUGHPUT ASSAY

(71) Applicant: Frederick G. Strathmann, Salt Lake City, UT (US)

(72) Inventor: Frederick G. Strathmann, Salt Lake City, UT (US)

(21) Appl. No.: 13/757,513

(22) Filed: Feb. 1, 2013

(51) Int. Cl. G06F 17/30

(52) U.S. Cl. CPC G06F 17/30386
USPC 707/752

(57) ABSTRACT

Computer systems and associated computer-implemented methods designed to monitor and mitigate the risk of reporting false positive results for high-throughput assays performed in or prepared in multi-well format plates (e.g., 96 well plates). Such computer systems and methods provide a quality-control program to automatically monitor and detect false-positive results based identifying samples in a multi-well assay format having low detected concentrations of a selected analyte that are in close proximity to samples having extremely elevated concentrations of the selected analyte.

### BACKGROUND

In all areas of laboratory testing, the clinical laboratory must ensure proper quality measures are in place to reduce false positive and false negative results. Some testing techniques are generally assumed to be better than others (e.g., less prone to yielding false positive and false negative results). For example, quantitative, confirmatory testing using liquid chromatography-tandem mass spectrometry is often taken at face value to be more specific than qualitative, antibody-based detection methods, but this is not always true.

The transition from individual vial to 96-well based, high-throughput sample preparation methods is one of many examples of the progress in clinical laboratory testing. Samples can be processed more rapidly and many automated systems have been developed for processing 96-well plates. Nevertheless, small sample volumes and the small form factor of 96-well plates may increase the likelihood of false-positive results for wells in close proximity to significantly elevated wells. For example, an increased likelihood of false-positive results for wells in close proximity to significantly elevated wells at a rate of approximately 4% has been observed in mass-spectrometry analysis of drugs of abuse using a 96-well format. Initially, it seemed that this process could be effectively controlled through manual processes. However, these manual processes were found to be time consuming and they unnecessarily predisposed the workflow and staff to potential for error. Although numerous attempts were made to identify and optimize all steps in the workflow to reduce well-to-well contamination, no tested improvement measures provided enough certainty to warrant removal of routine, manual checking Error rates may be expected to increase as high-throughput assays are transitioned to plates having a greater number of wells (e.g., 384 well plates or even 1536 well plates).

### BRIEF SUMMARY

Described herein are computer systems and associated computer-implemented methods designed to monitor and mitigate the risk of reporting false positive results for high-throughput assays performed in or prepared in multi-well format plates (e.g., 96 well plates). The computer systems and methods described herein provide a quality-control program to automatically monitor and detect false-positive results based on identifying samples in a multi-well assay format having low detected concentrations of a selected analyte that are in close proximity to samples having extremely elevated concentrations of the selected analyte.

In an embodiment, a computer system is described. The computer system includes one or more processors, system memory, and one or more computer-readable storage media. The computer-readable storage media include computer-executable instructions that, when executed by the one or more processors, cause the computing system to perform a method for providing visual output for a sample array. The method includes (1) an act of accessing one or more raw data points that include data values for samples in the sample array and (2) an act of determining the order in which the data values for samples in the sample array were collected. Based on the ordering determination, the method further includes (3) an act of assigning each of the one or more accessed data points to its original position in the sample array, and (4) an act of generating a graphical output that shows the assigned position of the data points in their original position on the sample array.

In another embodiment, a computer-implemented method for detecting false positives in a sample array. At a computer system including at least one processor and a memory, in a computer networking environment including a plurality of computing systems, the computer-implemented method includes (1) an act of accessing one or more raw data points that include data values for samples in the sample array and (2) an act of determining the order in which the samples were taken. Based on the ordering determination, the method further includes (3) an act of assigning each of the one or more accessed data points to its original position in the sample array, (4) an act of generating a graphical output that illustrates the assigned position of the data points in their original position on the sample array, and (5) an act of using the generated graphical output to identify one or more positives below a first selected threshold value that are adjacent to one or more positives above a second selected threshold value.

In a further embodiment, a computer system is described. The computer system includes one or more processors, system memory, and one or more computer-readable storage media. The computer-readable storage media include computer-executable instructions that, when executed by the one or more processors, cause the computing system to perform a method for providing one or more visual outputs for a sample array that includes a plurality of test samples. The method includes (1) an act of accessing one or more raw data points that include data values for samples in the sample array, the data values including values for a specified analyte and an internal standard, (2) an act of determining a degree of internal standard recovery for the sample array, (3) an act of identifying one or more positives for the specified analyte above a first selected threshold value, (4) an act of determining the order in which the data values for samples in the sample array were collected. Based on the ordering determination, the method further includes (5) an act of assigning each of the one or more accessed data points to its original position in the sample array, (6) an act of generating a one or more graphical outputs, and (7) an act of using the one or more graphical outputs to identify samples for reanalysis based on one or more selected criteria.

The act of generating the graphical output may include (a) an act of generating a first graphical output that relates internal standard recovery to position in the sample array, (b) an act of generating a second graphical output that relates measured concentration of the specified analyte to position in the sample array, and/or (c) an act of using at least one of the first generated graphical output or the second generated graphical output to generate a third graphical output that illustrates proximity of positives for the specified analyte below a second selected threshold value to positives for the specified analyte above the first selected threshold value.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which at least one embodiment described herein may operate including a method for providing visual output for a sample array.

FIG. 2 illustrates a computer architecture in which at least one embodiment described herein may operate including a method for providing one or more visual outputs for a sample array that includes a plurality of test samples.

FIG. 3 illustrates a flowchart of an example method for providing visual output for a sample array.

FIG. 4 illustrates a flowchart of an example method for providing one or more visual outputs for a sample array that includes a plurality of test samples.

FIG. 5 illustrates an embodiment of an internal standard plate map for an amphetamine confirmation assay.

FIG. 6 illustrates an embodiment of a sample plate map for an amphetamine confirmation assay.

FIG. 7 illustrates an embodiment of a sample interpretation plate map for an amphetamine confirmation assay.

FIG. 8A illustrates a blown-up region of the sample plate map of FIG. 6.

FIG. 8B illustrates a blown-up region of the sample interpretation plate map of FIG. 7.

### DETAILED DESCRIPTION

### I. Introduction

Described herein are computer systems and associated computer-implemented methods designed to monitor and mitigate the risk of reporting false positive results for high-throughput assays performed in or prepared in multi-well format plates (e.g., 96 well plates). The computer systems and methods described herein provide a quality-control program to automatically monitor and detect false-positive results based on identifying samples in a multi-well assay format having low detected concentrations of a selected analyte that are in close proximity to samples having extremely elevated concentrations of the selected analyte.

The computer systems and associated computer-implemented methods described herein provide an automated quality control tool for monitoring data obtained from high-throughput clinical assays. While high throughput systems have been a real boon to clinical testing laboratories, these methods do carry risks. For example, because these samples are prepared in large batches, they are subject to systematic errors and random errors in sample preparation and processing. In addition, because the technician's connection to any individual sample is reduced, the tracking of errors can be problematic.

The computer systems and associated computer-implemented methods described herein provide systems for tracking sample handling and analysis results for samples processed and/or assayed in a sample array format. As used herein, the term “sample array” refers to a set of samples that are prepared and/or run as a batch in a multi-well format (e.g., a 96 well plate). For example, while the samples are arranged in an array as dictated by the multi-well format, the data itself may be collected in a way that makes it difficult to see the relationship between neighboring samples. Thus, in one aspect, the computer systems and associated computer-implemented methods described herein are capable of collecting all of the data collected from an array of samples, sorting the data so that it can be assigned to its original position in the array, and generating one or more graphical outputs that allow the technician to easily see the relationship(s) between neighboring samples.

For example, the computer systems and associated computer-implemented methods described herein may analyze internal standard data based upon lab targets and output an internal standard plate map that shows the sample array and assigns colors or another suitable visual metric for the internal standard plate map based upon percent deviation.

In another example, the computer systems and associated computer-implemented methods described herein may collect and output sample data on a sample data plate map that shows the sample array and assigns colors or another suitable visual metric to the samples to show detection of an analyte in selected ranges. Furthermore, the computer systems and associated computer-implemented methods described herein may analyze the sample data and flag so-called “hotspots” on the sample date plate map. “Hotspots” are samples with extremely high positive values such that even a very small amount of carryover (e.g., about 1-2%) from the hotspot to a neighboring sample would be sufficient to cause the neighboring negative sample to come up positive. What constitutes an “extremely high positive value” will depend to some extent on the concentration range of the analyte and on the limit of detection.

In yet another example, the computer systems and associated computer-implemented methods described herein may use either the internal standard plate map or the sample data plate map to generate a sample interpretation plate map that flags samples for reanalysis based on selected criteria. For example, the computer systems and associated computer-implemented methods described herein may (a) find all the potential hotspots based upon elevated concentrations, (b) for each potential hotspot, determine its location on the sample array (e.g., on the 96-well plate) and the location of the surrounding well (there may be up to 8 surrounding wells in a 96-well format), and (c) generates a sample interpretation plate map that and assigns colors or another suitable visual metric to positives that border a hotspot and that are below a selected threshold. Samples that are low positives that border a hotspot may be flagged for reanalysis to confirm whether or not they are true positives. Likewise, samples showing aberrant internal standard recovery may also be flagged for reanalysis using a similar procedure.

### II Computer Systems and Computer-Implemented Methods

The following discussion now refers to a number of computer systems and associated computer-implemented methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

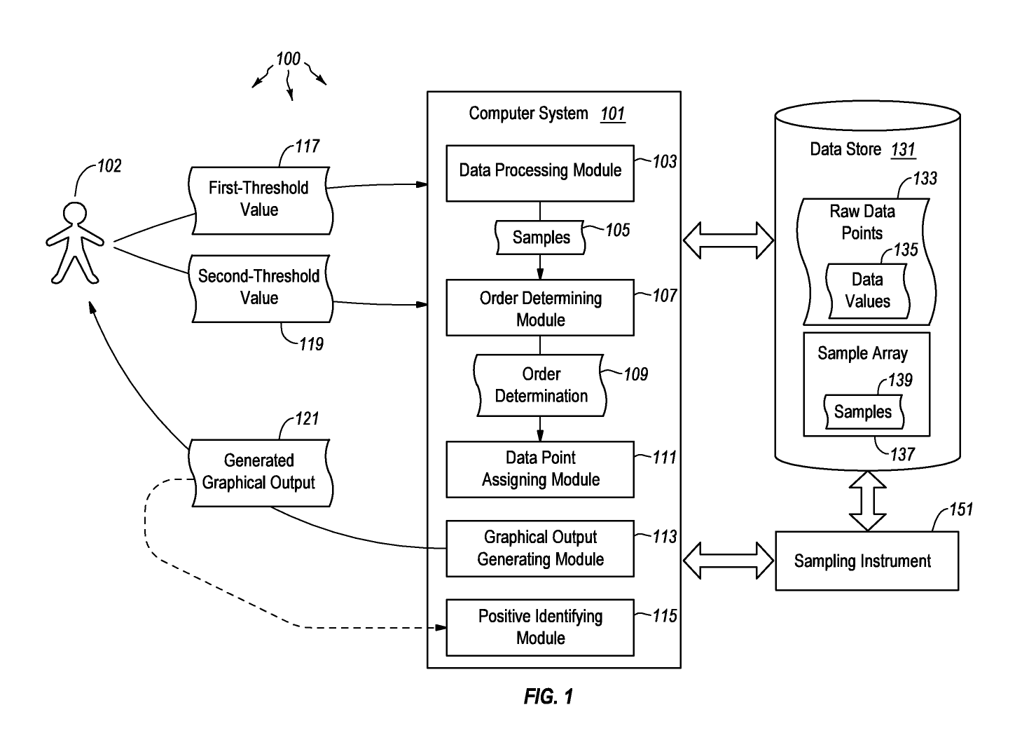

FIG. 1 illustrates a computer architecture 100 in which at least one embodiment may be employed. Computer architecture 100 includes computer system 101. Computer system 101 may be any type of local or distributed computer system, including a cloud computing system. The computer system 101 includes various modules for performing a variety of different functions. For instance, the computer system 101 is configured to interface with a data source 131 and a user interface 102. The various modules (and the user interface itself) may be run on a computer system that is local or distributed (e.g., a cloud computing system). The user interface may be configured to interact with a data source 131. The data source 131 may store data, or may simply act as a proxy that forwards data requests on to the actual location where the data is stored. The data source 131 may include multiple different data collections, each of which includes various different data elements.

In one embodiment, the computer system 101 includes a data accessing module 103 for accessing one or more raw data points that include data values for samples in a sample array. In one embodiment, the one or more raw data points that include data values for samples in the sample array are stored in the data source 131 at 133 and 135. The raw data points 133 may be supplied to the data source 131 by the sampling instrument 151. The raw data points 133 may, for example, include unprocessed and unsorted data (e.g., expressed as a series of numbers) collected by the sampling instrument. In one embodiment, the raw data points may include mass spectrometry data, data from an ELISA assay or a similar immunoassay, DNA sequencing data, and the like. In one embodiment, the raw data may be converted by the sampling instrument 151 or the computer system 101 to data values 135. For example, included mass spectrometry data may be converted from ion counts to a number that represents the concentration of an analyte of interest. In addition, the data source 131 may include data relating to the sample array 137 and the samples 139, such as, but not limited to, information about sample type(s), the analysis performed, the order the samples were collected in, etc.

The data accessing module 103 of the computer system 101 accesses the data source 131 and the sample data 105 is processed by the order determining module 107. The order determining module 107 determines the order in which the samples were collected. The output of the order determining module 109 is processed by the data point assigning module 111 that assigns each of the one or more accessed data points to its original position in the sample array.

The assigned data points are processed by the graphical output generating module 113 to generate a graphical output 121 that shows the assigned position of the data points in their original position on the sample array. The generated graphical output 121 can be displayed on the user interface 102. Based on an input first threshold value 117 and an input second threshold value 119, the generated graphical output 121 can be used to flag samples for reanalysis. For example, positives below the second threshold value 119 that are adjacent to samples above the first threshold value 117 may be flagged for reanalysis because the positives below the second threshold value 119 may not be true positives. The samples flagged for reanalysis may be flagged manually at the user interface 102, or they may be flagged automatically at a positive identifying module 115.

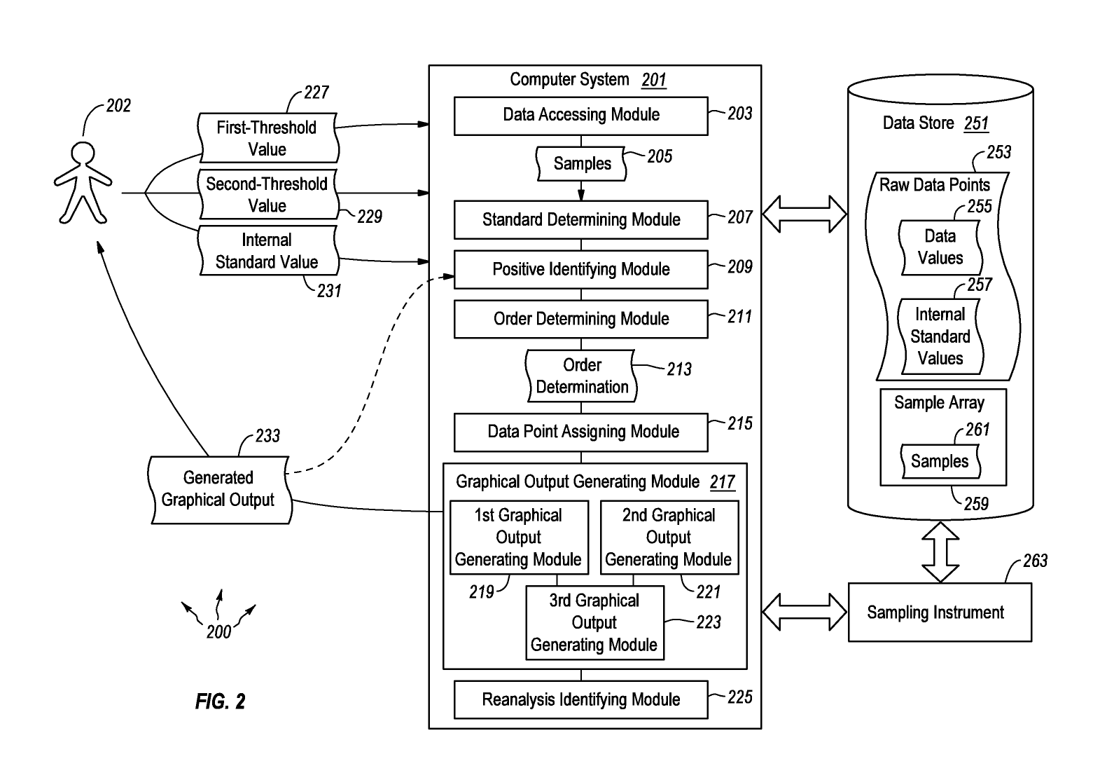

Referring now to FIG. 2, a second computer architecture 200 is illustrated in which at least one embodiment may be employed. Computer architecture 200 includes computer system 201. Computer system 201 may be any type of local or distributed computer system, including a cloud computing system. The computer system 201 includes various modules for performing a variety of different functions. For instance, the computer system 201 is configured to interface with a data source 251 and a user interface 202. The various modules (and the user interface itself) may be run on a computer system that is local or distributed (e.g., a cloud computing system). The user interface 202 may be configured to interact with a data source 251. The data source 251 may store data, or may simply act as a proxy that forwards data requests on to the actual location where the data is stored. The data source 251 may include multiple different data collections, each of which includes various different data elements.

In one embodiment, the computer system 201 includes a data accessing module 203 for accessing the data store 251. The data accessed may include one or more raw data points 253 for data collected for the sample array. The one or more raw data points 253 may include data values 255 for samples in a sample array and internal standard values 257 for samples in a sample array. The raw data points 255 and the internal standard values 257 may be supplied to the data source 251 by the sampling instrument 263. In addition, the data source 251 may include data relating to the sample array 257 and the samples 261, such as, but not limited to, information about sample type(s), the analysis performed, the order the samples were collected in, etc.

The data accessing module 203 of the computer system 201 accesses the data source 251 and the accessed sample data 205 may be processed by one or more of the standard determining module 207 that is configured for determining the standard recovery in the accessed sample data or the order determining module 211. The order determining module 211 determines the order in which the samples were collected. The output of the order determining module 213 is processed by the data point assigning module 215 to assign each of the one or more accessed data points to its original position in the sample array.

The assigned data points are processed by the graphical output generating module 217 to generate a graphical output 233 that shows the assigned position of the data points in their original position on the sample array. The generated graphical output 233 can be displayed on the user interface 202. Based on an input first threshold value 227, an input second threshold value 229, and/or an input internal standard value 231, the generated graphical output 233 can be used to flag samples for reanalysis. Samples can be flagged for reanalysis manually or based on a reanalysis identifying module 225.

In one embodiment, the generated graphical output 233 may be output by a first graphical output generating module 219. The first graphical output may include a graphical output that relates internal standard recovery to position in the sample array. In another embodiment, the generated graphical output 233 may be output by a second graphical output generating module 221. The second graphical output may include a graphical output that relates measured concentration of the specified analyte to position in the sample array. In yet another embodiment, the generated graphical output 233 may be output by a third graphical output generating module 223. The third graphical output may include a graphical output that illustrates proximity of positives for the specified analyte below a second selected threshold value to positives for the specified analyte above the first selected threshold value. The third graphical output generating module may take inputs from the first graphical output generating module 219 or the second graphical output generating module 221.

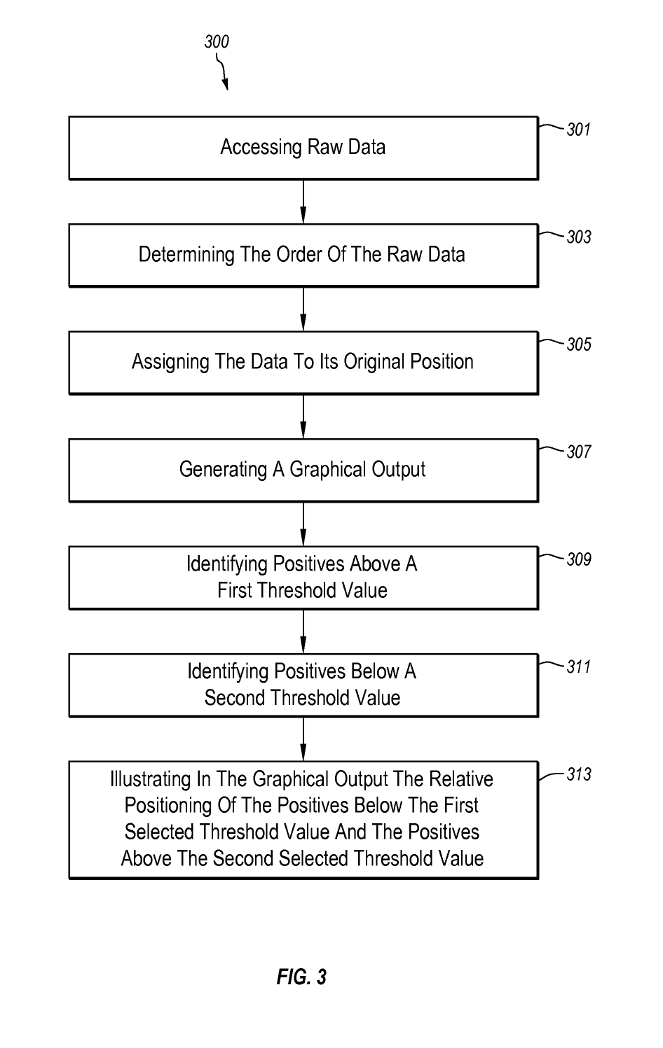

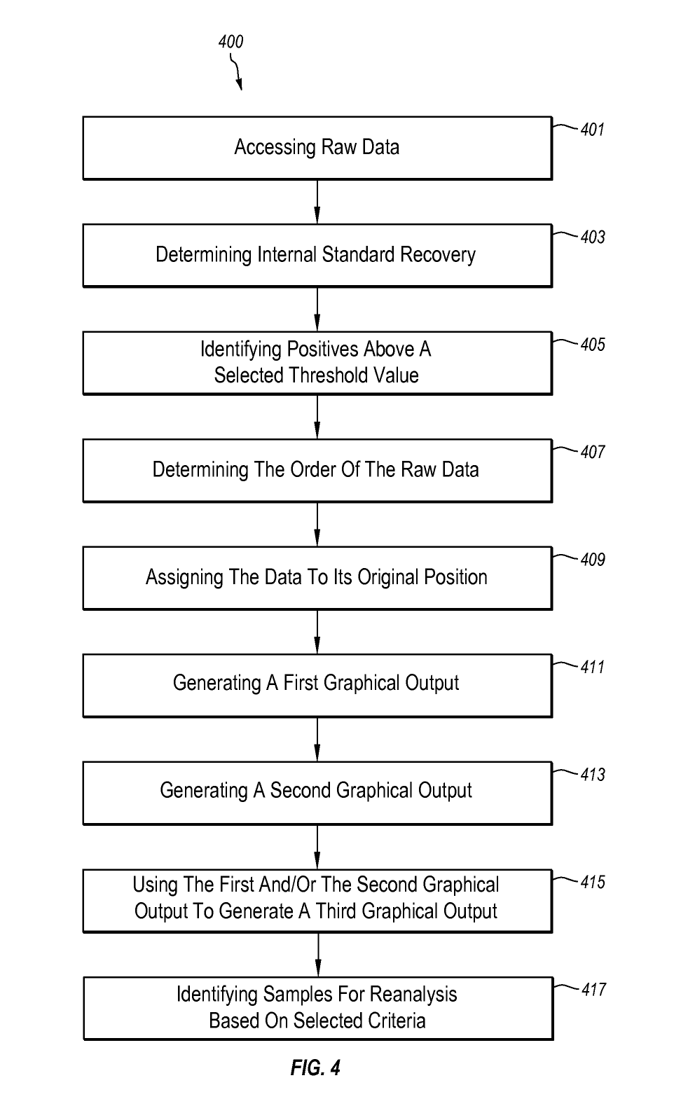

These concepts will be explained further below with regard to methods 300 and 400 of FIGS. 3 and 4, respectively. In particular, the modules described above in the computer architectures 100 and 200 may be specially adapted to perform the methods described herein.

In view of the systems and architectures described above, methodologies that may be implemented in accordance with the disclosed subject matter will be better appreciated with reference to the flow charts of FIGS. 3 and 4. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 3 illustrates a flowchart of a method 300 for providing visual output for a sample array. The method 300 includes an act 301 of accessing one or more raw data points that include data values for samples in the sample array. For example, as explained above, the one or more raw data points may be stored in the data source 131 or 151. The raw data points may be provided to the data source 131 or 151 by the sampling instrument 151 or 263.

The method further includes an act 303 of determining the order in which the data values for samples in the sample array were collected. The act 303 of determining the order in which the data was collected may, for example, be performed by the order determining module 107 or 211 of the computer system 101 or 201. The information needed for determining the order in which the data was collected may, for example, be provided by the sampling instrument 151 or 263. In one example, data determining the order in which the raw data values were collected may be included in a file with the raw data values.

Based on the ordering determination, the method 300 further includes an act 305 of assigning each of the one or more accessed data points to its original position in the sample array, and an act 307 of generating a graphical output that shows the assigned position of the data points in their original position on the sample array. In one embodiment, the act 307 of generating a graphical output includes illustrating the detected concentration range of an analyte of interest on the graphical output. In one embodiment, the act of representing in the graphical output a concentration value range includes assigning a color code to selected concentration range values.

In one or more embodiments, the method 300 further includes an act 309 of identifying one or more positives above a first selected threshold value, an act 311 of using the generated graphical output to identify one or more positives below a second selected threshold value that neighbor the one or more identified positives, and an act 313 of illustrating in the graphical output the relative positioning of the positives above the first selected threshold value (i.e., very high positives) and the positives below the second selected threshold value (i.e., low positives). In one example, acts 309, 311, and 313 may be performed automatically (e.g., by the computer system 101 or 201) using the graphical output.

As explained elsewhere herein, when low positives are neighbored by very high positives, it is possible that the low positives are not true positives. Generally, low positives are “positives” in the sense that the instrument has actually detected an analyte of interest, but they may not be “true” positives in the sense that they are showing a positive result as a result of contamination from the neighboring high positives. As such, the method may further include an act of reanalyzing at least a subset of the identified positives below the second selected threshold value. In particular, identified positives below the second selected threshold value may be reanalyzed if they are neighbored by identified positives above the first selected threshold value.

In one embodiment, the method includes an act of collecting data values for samples in the sample array in a prescribed order. In another embodiment, the method includes an act of collecting data values for samples in the sample array substantially at random. In any case, the act 305 of assigning each of the one or more accessed data points to its original position in the sample array may be used to assign the data to its position on the sample array regardless of the order in which the data is collected. In one embodiment, the method may include determining the order in which the data values for samples in the sample array were collected by sending a query to a data collection instrument.

In one embodiment, the samples include clinical laboratory samples. Suitable examples of clinical laboratory samples include, but are not limited to, drug testing samples, immunoassay samples, DNA sequencing samples, endocrinology testing samples, therapeutic drug monitoring samples, pain management testing samples, toxicology testing samples, biochemical genetics testing samples, newborn screening samples, and the like.

In one embodiment, the method further includes an act of including an identifier sample in the sample array for tracking the array of samples. For example, the identifier sample may include one of a blank or a null sample. In addition, the tracking sample can be inserted into the array of samples in a unique location (e.g., a random location) so that the identifier sample can be used to distinguish a given sample array from another sample array.

Referring now to FIG. 4, FIG. 4 illustrates a flowchart of a method 400 for providing one or more visual outputs for a sample array that includes a plurality of test samples. As explained in greater detail above with reference to the computer system environments 100 and 200 and in reference to method 300, the method steps of method 400 may be performed in computer system environment 100 or 200.

The method 400 includes an act 401 of accessing one or more raw data points that include data values for samples in the sample array, the data values including values for a specified analyte and an internal standard. The method 400 further includes an act 403 of determining a degree of internal standard recovery for the sample array, an act 405 of identifying one or more positives for the specified analyte above a first selected threshold value, and an act 407 of determining the order in which the data values for samples in the sample array were collected. Based on the ordering determination, the method 400 further include an act 409 of assigning each of the one or more accessed data points to its original position in the sample array.

The method 400 further includes an act 411 of generating a first graphical output that relates internal standard recovery to position in the sample array. In one example, such a graphical output can be used to monitor sample preparation and to monitor possible defects in the samples. For example, the internal standards should provide a known recovery—i.e., a known concentration of the internal standard should be detected. If the recovery of the internal standard deviates from the known value, it may be indicative of systematic errors in sample preparation (e.g., too much or too little internal standard added) or suppression or enhancement of internal standards consistent with matrix effects.

The method 400 further includes an act 413 of generating a second graphical output that relates measured concentration of the specified analyte to position in the sample array. In one example, such a graphical output can be used identify so-called “hotspots” in the sample array—i.e., samples in the sample array having an extremely high positive concentration of an analyte of interest. In addition to showing samples in the sample array having an extremely high positive concentration of the analyte of interest, the graphical output may also show samples in the array that are immediately adjacent to the hotspot(s) that have detected concentrations of the selected analyte that are below a selected threshold value. When samples immediately adjacent to the hotspots show detected concentrations of the selected analyte that are below the selected threshold value, it has been determined by the inventor that such positives may not be true positives but may instead be the result of contamination from the hotspot(s).

The method 400 further includes an act 415 of using at least one of the first generated graphical output or the second generated graphical output to generate a third graphical output. The third graphical output can be used, for example, in an act 417 of identifying samples for possible reanalysis based on selected criteria. For example, the third graphical output may identify (i.e., flag) samples for reanalysis because they are positives for the specified analyte below a selected threshold value that are in proximity to so-called “hotspots” (i.e., positives for the specified analyte above a selected threshold value). Likewise, the third graphical output may flag samples for reanalysis if they show aberrant recovery of the internal standard. Other selected criteria for flagging samples for reanalysis may be identified by the inventor and included in the computer systems and methods without deviating from the scope and spirit of the disclosure presented herein.

### Examples

The following examples illustrate use of the computer systems and methods for quality monitoring of clinical samples analyzed liquid chromatography-tandem mass spectrometry (“LC-MS/MS”) according to at least one embodiment of the present invention. While these examples are specific to quality monitoring of LC-MS/MS samples, the principles discussed in this section are applicable to quality monitoring of essentially any high-throughput analysis.

Clinical Samples

Urine samples used in this study were submitted for LC-MS/MS confirmation testing at ARUP laboratories in Salt Lake City, Utah. The data presented were part of routine clinical testing and quality assurance procedures.

Clinical Assays

Contamination of wells in proximity to elevated samples was investigated for urine LC-MS/MS assays detecting the following compounds: amphetamine, MDA, MDEA, MDMA, methamphetamine, N-desmethylselegiline, phentermine, pseudoephedrine, methylphenidate, ritalinic acid, selegiline, EDDP, methadone, 6-acetyl morphine, codeine, dihydrocodeine, hydrocodone, hydromorphone, morphine, oxycodone, oxymorphone, and THC.

Assay Description

Confirmation testing for the drugs listed above utilizes similar sample preparation procedures including internal standard addition prior to solid phase extraction using 96-well Phenomenex Strat X-C solid phase preassembled plates. Chromatographic separation and analysis using multiple reaction monitoring was conducted using a Waters Acquity Ultra performance LC-MS/MS system equipped with a Waters Acquity UPLC system, Acquity HSS C18 UPLC 1.8 μm particle size, 2.1×50 mm analytical column and ESCI probe in positive electrospray ionization mode.

Program Description

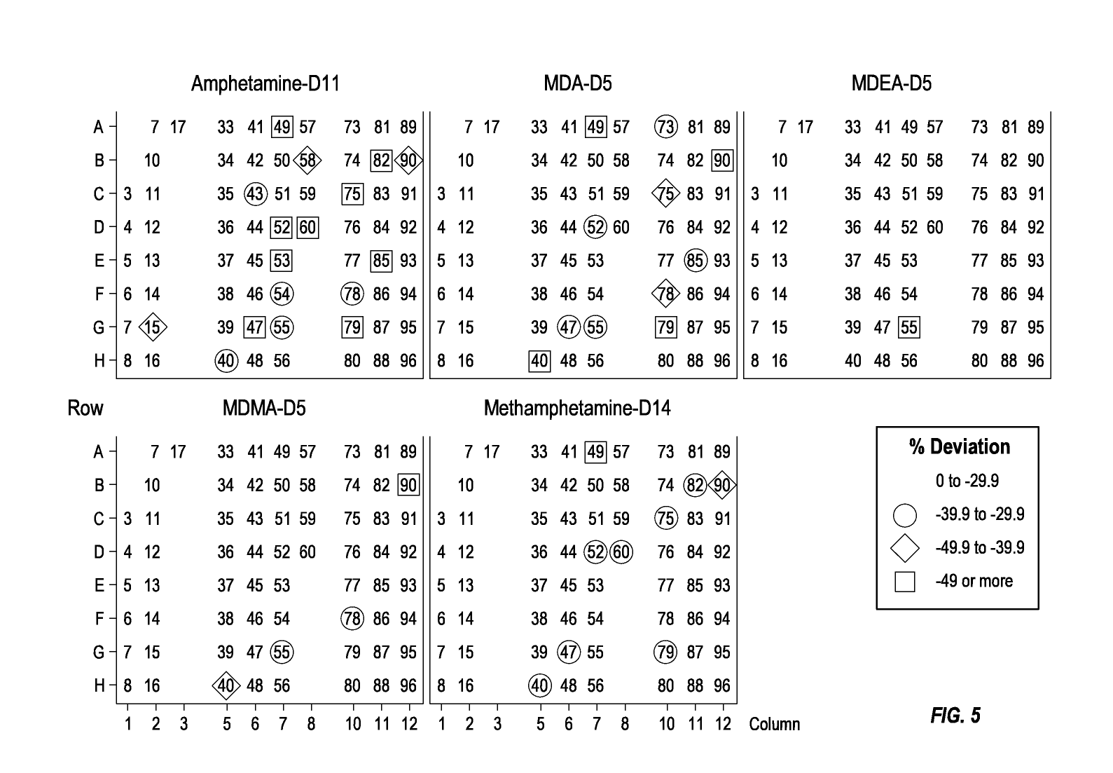

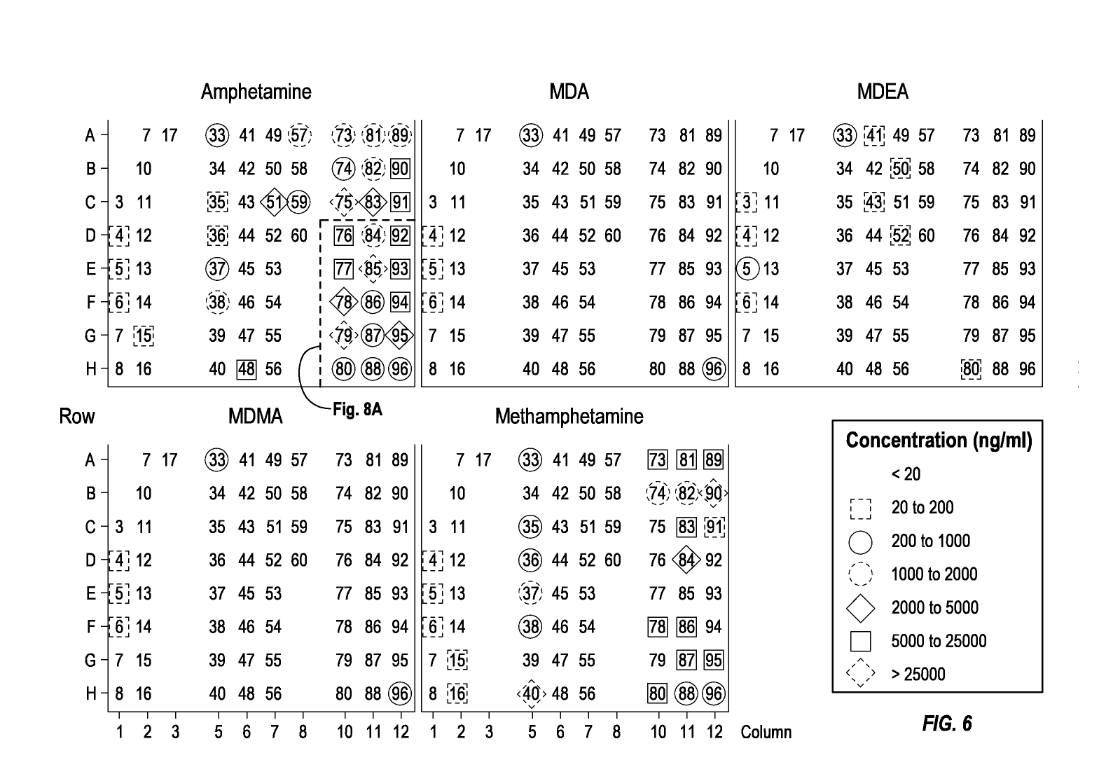

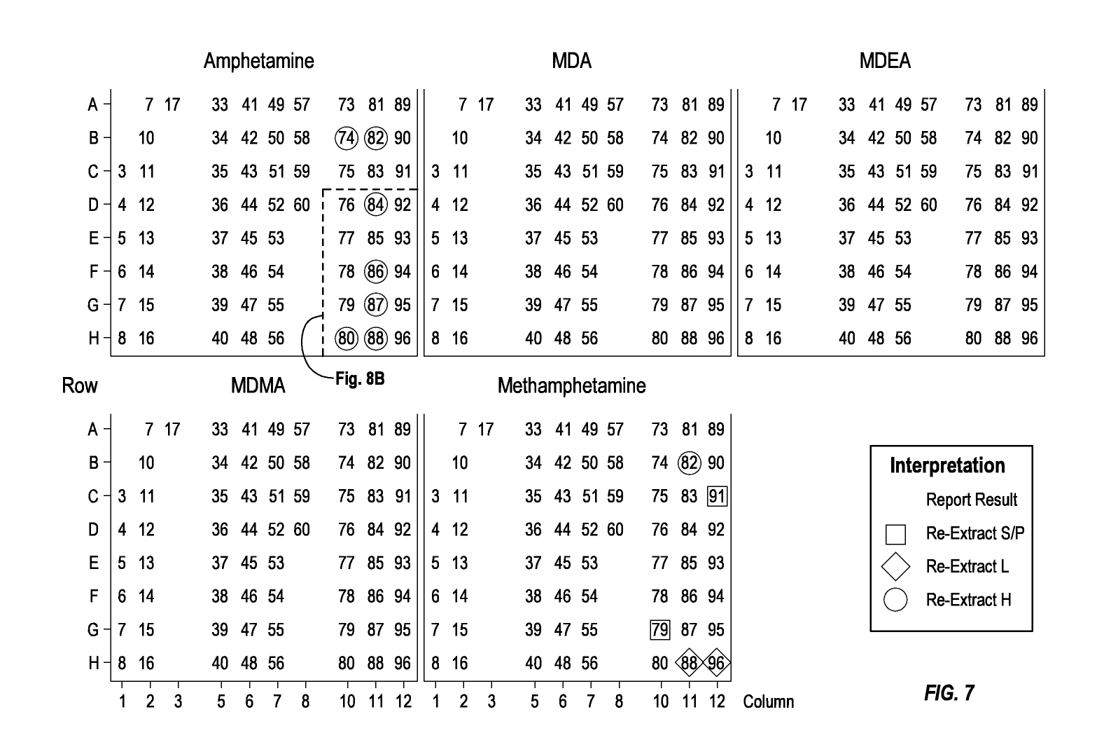

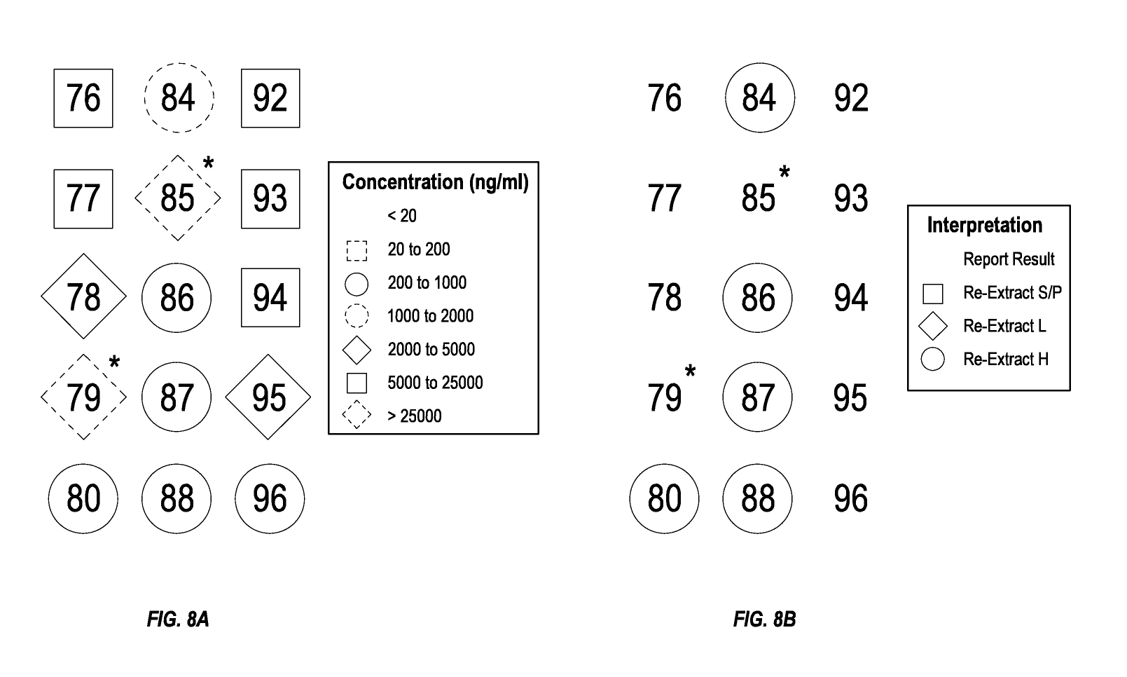

The quality analysis program (i.e., the “Hotspot program”) was written using the statistical language R with graphics generated using the ggplot2 package. Raw data was exported as a text file from the MassLynx software. Three images were generated for each data file: an internal standard plate map (FIG. 5), a sample plate map (FIG. 6), and a sample interpretation plate map (FIG. 7). Blown up regions of the plate maps shown in FIGS. 6 and 7 are illustrated in FIGS. 8A and 8B. The sample plate map (FIG. 6) is a representation of the original 96-well plate and is generated by plotting horizontal plate location on the x-axis (1 to 12) and vertical plate location on the y-axis (A to H). Data was binned using final concentration based upon laboratory derived criteria with each bin assigned a specific shape depending on the concentration range. Alternatively, each bin may be assigned a specific color similar to the encoding used in heat map graphics (e.g., white for low concentration, red for high concentration). A similar graphical representation of the relative percentage of internal standard recovery (FIG. 5) was used based upon laboratory acceptance criteria in line with regulatory guidelines. The sample interpretation graph (FIG. 7) may be generated using the following method, or an embodiment of a method described herein. The method may include 1) identification of samples where the concentration of any analyte exceeds a laboratory derived threshold; 2) determination of concentrations for the immediately adjacent samples to those identified in step one; and 3) assignment of a visual flag to any adjacent samples with concentrations exceeding laboratory derived criteria. In a 96-well plate, each well has eight neighbors; other formats (e.g., 384 well plates or 1536 well plates) will have different numbers of neighbors.

Results

Internal Standard Deviation

The Hotspot program was written as a quality control program to help identify problem specimens due to analytical complications not readily identifiable during sample processing. Monitoring of internal standards is an important component to laboratory analysis quality control and aids in identifying samples where recovery was compromised or sample processing deviated from the established standard operating procedure (e.g., inaccurate pipetting). In the present mass spectrometry example, the MassLynx program generates a percent deviation for each internal standard present in the sample by dividing the sample internal standard area by the average of the internal standard areas for the calibrators. FIG. 5 is a representative internal standards plate map generated for various deuterated amphetamines, amphetamine derivatives and metabolites used for normalization from an LC-MS/MS amphetamine confirmation run. The majority of internal standard recoveries were within 30% deviation while a subset had greater than 49% deviation.

Sample Layout and Initial Identification

Prior to the implementation of the Hotspot program, technologists would manually scan analysis reports in an effort to identify elevated samples above a laboratory set threshold, pinpoint up to eight surrounding samples for each elevated sample, and determine if any surrounding sample results were characteristic of contamination due to their proximity to the elevated result. The manual process made use of a repeated, sequential numbering system for each well in a given 96-well plate; however, the process required extensive analysis of the data, a working knowledge of laboratory thresholds, and, because such reports do not present data in a manner that relates data lines to the position of the samples in the well plate, included a time-consuming process of identifying surrounding wells and detection of potential contamination.

In contrast, using the Hotspot program, a graphical layout of the 96-well is generated from the exported, raw data without the need for review or manipulation by the technologist. FIG. 6 is the resultant plate map for each analyte and sample in a quantitative LC-MS/MS confirmatory method for amphetamines, amphetamine derivatives and metabolites. Each well is categorized based upon laboratory established criteria with each bin corresponding to a specific shape as indicated in the figure legend. Wells without a sample are excluded from the graph and each analyte in the multiplex assay has an individual plate layout generated. The individual numbers correspond to the sequence in the original sample list for the batch. Viewing the data in this manner provides an overview of concentration ranges for each analyte, the distribution of elevated samples across the plate, and a mechanism to quickly correlate parent drug with expected metabolites when contamination is suspected.

A blown up region of the amphetamine plate map of FIG. 6 is illustrated in FIG. 8A. FIG. 8A illustrates the same data as is FIG. 6, but the selected region is magnified for ease of viewing. As can be seen in FIG. 8A, there are two hotspots at positions 79 and 85. The hotspots are indicated by asterisks. The samples at positions 79 and 85 each have detected concentrations of greater than 25,000 ng/ml of amphetamine. The samples at positions 79 and 85 are so high that even a small amount (e.g., 1-2%) of sample carryover from position 79 or 85 to an adjacent well would be enough to trigger a false positive. In the wells neighboring well 79, low positives below the selected threshold value (e.g., 200-1000) were detected at positions 80, 86, 87, and 88. In the wells neighboring the hotspot at well 85, low positives (e.g., 200-1000 or 1000-2000 ng/ml) were detected at positions 84 and 86.

Sample Interpretation

FIG. 7 represents the automation of a laborious process; however, use of this graph alone still requires a technologist to identify the elevated samples and determine if any surrounding samples may be contaminated. Categorizing a sample as contaminated causes a delay in result reporting, requires re-extraction and re-analysis of the identified samples, and requires staff to compare the original and repeat values for any discrepancy. An appropriate threshold that maximizes both sensitivity and specificity is ideal to ensure all contaminated samples are identified while minimizing unnecessary rework and laboratory expense. Ongoing review of repeat data affords the opportunity to continuously adjust and refine the rules used for contamination identification but has a trade-off of over-complication for the laboratory staff. To simplify the interpretation process, a third graphic was generated with an identical layout to the plate map described in FIG. 6 but with coding (e.g., shape codes or color codes) corresponding to which samples can be reported and which samples need further evaluation and possible repeat testing. Samples that require repeat testing are placed into a Re-extract High or Re-extract Low based upon the concentration of the nearby elevated result. Re-extract High and Re-extract Low are terms used to indicate to the operator the approximate concentration of the original hotspot that trigged the flag by binning into two separate categories of high (Re-extract Low) and ultra-high (Re-extract High). By knowing the approximate concentration of the original hotspot the necessity for further evaluation can be prioritized. In addition, application of unique, predetermined thresholds for further evaluation and possible repeat testing based upon the category of Re-extract Low or Re-extract High may be necessary based upon a proportional carryover of ˜1-2% and the difference in possible interpretation of surrounding well concentrations. FIG. 7 is an example interpretation plate map for a quantitative LC-MS/MS confirmatory method for amphetamines, amphetamine derivatives and metabolites. Re-extract S/P indicates the application of unique thresholds to determine potential need for re-extraction and re-analysis for serum or plasma samples only.

A blown up region of the amphetamine plate interpretation map of FIG. 7 is illustrated in FIG. 8B. As with FIG. 8A, FIG. 8B illustrates the corresponding map of FIG. 7, but the selected region is magnified for ease of viewing. Again, the hotspots are indicated by asterisks. As can be seen in FIG. 8B, the low positive samples (samples 80, 84, 86, 87, and 88) around the two hotspots at positions 79 and 85 have been flagged for re-extraction and reanalysis because they appear to be possible false positives. That is, the hotspot samples are so highly concentrated that even a small amount (e.g., 1-2%) of sample carryover from position 79 or 85 to well 80, 84, 86, 87, or 88 would be enough to trigger a false positive. In some instances, samples may also be flagged for reextraction/reanalysis based on abnormal graphical patterns indicating systematic sample preparation failure at multiple locations throughout the sample preparation plate or identified suppression or enhancement of internal standards consistent with matrix effects.

Program Performance Characteristics

The program parameters listed in Table 1 (below) were derived based on observations from the clinical staff and discussions regarding the clinical impact of the detected carryover. Other program parameters may also be used. False negatives are not possible to capture during routine clinical testing; however, repeat testing of samples identified as being contaminated through use of the HotSpot program were used to determine True Positive, False Positive and Positive Predicted Value (“PPV”) for each analyte (Table 2) (below). PPVs ranged from 2.9% to 100% with an average PPV of 32% across all 18 analytes listed. The number of contaminated wells, if unmonitored, would have resulted in an average of 16 false positive results across all analytes in a 6 month period, with the majority of false positives for methamphetamine (99), amphetamine (92) and oxycodone (29). The reporting of false positives is generally unacceptable. However, the computer systems and methods described herein provide robust quality monitoring tools for identifying samples that may be showing a false positive and flagging samples for reanalysis based on selected criteria.

TABLE 1
Cutoffs for hotspot identification and contamination ranges for re-extraction.

| | Level 1 (ng/mL) | | Level 2 (ng/mL) | |
|---|---|---|---|---|
| | | Contamination | | Contamination |
| Compound Class | Hotspot Range | Range | Hotspot Range | Range |
| 6-AM | 5,000-25,000 | 5-20 | >25,000 | 5-200 |
| Amphetamine | 5,000-25,000 | 200-1000 | >25,000 | 200-2000 |
| Codeine | 5,000-25,000 | 5-20 | >25,000 | 5-200 |
| Dihydrocodeine | 5,000-25,000 | 5-20 | >25,000 | 5-200 |
| EDDP | 5,000-50,000 | 10-100 | >50,000 | 10-2000 |
| Hydrocodone | 5,000-25,000 | 5-20 | >25,000 | 5-200 |
| Hydromorphone | 5,000-25,000 | 5-20 | >25,000 | 5-200 |
| MDA | 5,000-25,000 | 200-1000 | >25,000 | 200-2000 |
| MDEA | 5,000-25,000 | 200-1000 | >25,000 | 200-2000 |
| MDMA | 5,000-25,000 | 200-1000 | >25,000 | 200-2000 |
| Methadone | 5,000-50,000 | 10-100 | >50,000 | 10-2000 |
| Methamphetamine | 102 | 3 | 99 | 2.94 |
| Morphine | 5,000-25,000 | 5-20 | >25,000 | 5-200 |
| Oxycodone | 5,000-25,000 | 5-20 | >25,000 | 5-200 |
| Oxymorphone | 5,000-25,000 | 5-20 | >25,000 | 5-200 |
| Phentermine | 5,000-25,000 | 200-1000 | >25,000 | 200-2000 |
| Pseudoephedrine | 5,000-25,000 | 200-1000 | >25,000 | 200-2000 |
| THC | 1000-10,000 | 5-20 | >10,000 | 5-100 |

TABLE 2
Performance of the HotSpot program during a 6 month period.

| | Putative | True | False | Positive Predicted |
|---|---|---|---|---|
| Analyte | Hotspots | Positive | Positive | Value |
| 6-AM | 1 | 1 | 0 | 100 |
| Amphetamine | 95 | 3 | 92 | 3.16 |
| Codeine | 5 | 3 | 2 | 60 |
| Dihydrocodeine | 0 | 0 | 0 | |
| EDDP | 15 | 5 | 10 | 33.3 |
| Hydrocodone | 29 | 10 | 19 | 34.5 |
| Hydromorphone | 2 | 0 | 2 | 0 |
| MDA | 0 | 0 | 0 | — |
| MDEA | 0 | 0 | 0 | — |
| MDMA | 0 | 0 | 0 | — |
| Methadone | 2 | 1 | 1 | 50 |
| Methamphetamine | 102 | 3 | 99 | 2.94 |
| Morphine | 30 | 11 | 19 | 36.7 |
| Oxycodone | 60 | 31 | 29 | 51.7 |
| Oxymorphone | 1 | 0 | 1 | 0 |
| Phentermine | 2 | 0 | 2 | 0 |
| Pseudoephedrine | 0 | 0 | 0 | — |
| THC | 5 | 2 | 3 | 40 |

### CONCLUSIONS

Regardless of sample volume, all laboratories are increasingly interested in ways to maximize staff efficiency. The increased use of liquid chromatography-tandem mass spectrometry for clinical laboratory testing has enhanced the ability to develop high-throughput, multiplexed testing. However, such testing requires highly-skilled operators, extensive data review and varying degrees of complexity in sample preparation. As clinical mass spectrometry continues to evolve so too does our understanding of the unique challenges and needs essential to provide the expected level of quality control.

The inventor has identified a potentially underappreciated quality issue possibly affecting any 96-well based clinical assay. Even though the specific step in the sample preparation responsible for the carryover has not yet been identified or remedied, it is hypothesized that the steps conducted during the extraction procedure are the likely sources. To ensure that laboratories could effectively and quickly monitor the resultant quality concerns, the inventor has developed a quality control tool for use in the clinical laboratory to aid in the identification of well-to-well contamination in 96-well, high throughput LC-MS/MS assays. Use of the HotSpot program has reduced the need for laborious data review by staff and has substituted a manual process with a robust, automated method amenable to refinement and modification without requiring staff retraining.

The data presented in these examples are from urine drug of abuse confirmatory testing conducted on a Waters Acquity UPLC-MS/MS and exported using MassLynx software; however the code has been adapted for alternate platforms and is run using a freely available, cross-platform programming language. Monitoring for hotspot false positives has identified a 4% contamination rate overall and use of the HotSpot program has enabled tighter control over laboratory quality without substantially impacting laboratory workflow. This has shed light on the considerable need for the development of novel quality control tools designed to monitor the multiplexed, high-throughput assays currently being developed and performed in clinical laboratories.

Accordingly, methods, systems and computer program products are provided that are capable of monitoring and mitigating the risk of reporting false positive results for high-throughput assays performed in or prepared in multi-well format plates (e.g., 96 well plates). Such computer systems and methods provide a quality-control program to automatically monitor and detect false-positive results based identifying samples in a multi-well assay format having low detected concentrations of a selected analyte that are in close proximity to samples having extremely elevated concentrations of the selected analyte. Moreover, methods, systems and computer program products are provided that monitoring and mitigating the risk of reporting incorrect data resulting from, for example, errors in sample preparation and/or sample matrix effects.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A computer system comprising the following:
one or more processors;
system memory;
one or more computer-readable storage media having stored thereon computer-executable instructions that, when executed by the one or more processors, causes the computing system to perform a method for providing visual output for a sample array, the method comprising the following:
an act of accessing one or more raw data points that include data values for samples in the sample array;
an act of determining the order in which the data values for samples in the sample array were collected;
based on the ordering determination, an act of assigning each of the one or more accessed data points to its original position in the sample array;
an act of generating a graphical output that shows the assigned position of the data points in their original position on the sample array.

2. The computer system of claim 1, wherein the method further comprises:
an act of identifying one or more positives above a first selected threshold value; and
an act of using the generated graphical output to identify one or more positives below a second selected threshold value that neighbor the one or more identified positives.

3. The computer system of claim 2, wherein the method further comprises an act of reanalyzing at least a subset of the identified positives below the second selected threshold value.

4. The computer system of claim 1, wherein the method comprises an act of collecting data values for samples in the sample array in a prescribed order.

5. The computer system of claim 1, wherein the method comprises an act of collecting data values for samples in the sample array substantially at random.

6. The computer system of claim 1, wherein the act of determining the order in which the data values for samples in the sample array were collected comprises sending a query to a data collection instrument.

7. The computer system of claim 1, wherein the samples comprise clinical laboratory samples.

8. At a computer system including at least one processor and a memory, in a computer networking environment including a plurality of computing systems, a computer-implemented method for detecting false positives in a sample array, the method comprising:
an act of accessing one or more raw data points that include data values for samples in the sample array;
an act of determining the order in which the samples were taken;
based on the ordering determination, an act of assigning each of the one or more accessed data points to its original position in the sample array;
an act of generating a graphical output that illustrates the assigned position of the data points in their original position on the sample array; and
an act of using the generated graphical output to identify one or more positives below a first selected threshold value that are adjacent to one or more positives above a second selected threshold value.

9. The computer-implemented method of claim 8, further comprising an act of representing in the graphical output a concentration value range for at least one analyte of interest in each of the samples of the sample array.

10. The computer-implemented method of claim 9, wherein the act of representing in the graphical output a concentration value range includes assigning a color code to selected concentration range values.

11. The computer-implemented method of claim 8, further comprising an act of illustrating in the graphical output the relative positioning of the one or more positives below the first selected threshold value and the one or more positives above the second selected threshold value.

12. The computer-implemented method of claim 8, further comprising an act of reanalyzing at least a subset of the identified positives below the first selected threshold value.

13. The computer-implemented method of claim 12, wherein positives below the first selected threshold value are reanalyzed as a function of being adjacent to a positive above the second selected threshold value.

14. The computer-implemented method of claim 8, further comprising an act of collecting data values for samples in the sample array in a prescribed order.

15. The computer-implemented method of claim 8, further comprising an act of collecting data values for samples in the sample array substantially at random.

16. The computer-implemented method of claim 8, wherein the act of determining the order in which the data values for samples in the sample array were collected comprises querying a data collection instrument.

17. The computer-implemented method of claim 8, wherein the samples comprise clinical laboratory samples.

18. The computer-implemented method of claim 8, further comprising an act of including an identifier sample in the sample array for tracking the array of samples, wherein the identifier sample includes one of a blank or a null sample.

19. The computer-implemented method of claim 18, wherein the identifier sample is inserted into the sample array in a random position.

20. A computer system comprising the following:
one or more processors;
system memory;
one or more computer-readable storage media having stored thereon computer-executable instructions that, when executed by the one or more processors, causes the computing system to perform a method for providing one or more visual outputs for a sample array that includes a plurality of test samples, the method comprising the following:
an act of accessing one or more raw data points that include data values for samples in the sample array, the data values including values for a specified analyte and an internal standard;
an act of determining a degree of internal standard recovery for the sample array;
an act of identifying one or more positives for the specified analyte above a first selected threshold value;
an act of determining the order in which the data values for samples in the sample array were collected;
based on the ordering determination, an act of assigning each of the one or more accessed data points to its original position in the sample array;
an act of generating a first graphical output that relates internal standard recovery to position in the sample array;
an act of generating a second graphical output that relates measured concentration of the specified analyte to position in the sample array; and
an act of using at least one of the first generated graphical output or the second generated graphical output to generate a third graphical output that identifies samples in the sample array for reanalysis based on one or more selected criteria.

21. The computer system of claim 20, wherein the one or more selected criteria comprise one or more of standard recovery above or below a selected value, a positive for the specified analyte below the second selected threshold value in proximity to a positive for the specified analyte above the first selected threshold value, abnormal graphical patterns indicating systematic sample preparation failure at multiple locations throughout the sample preparation plate or identified suppression or enhancement of internal standards consistent with matrix effects.
